(19) United States
(12) Patent Application Publication
(10) Pub. No.: US 2009/0172406 A1
(43) Pub. Date: Jul. 2, 2009

(54) METHOD AND SYSTEM FOR PROTECTING PATIENT DATA

(76) Inventor: Diansong CAO, Beijing (CN)

Correspondence Address: Patrick W. Rasche;Armstrong Teasdale LLP, Suite 2600, One Metropolitan Squarc, St. Louis, MO, 63102, US

(21) Appl. No.: 12/339,397

(22) Filed: Dec. 19, 2008

(30) Foreign Application Priority Data
Dec. 28, 2007 (CN) 200710300496.4

(51) Int. Cl. H04L 9/32; G06F 3/00

(52) U.S. Cl. 713/183; 710/9

(57) ABSTRACT

A method for a medical system to transmitting patient information to an external USB storage device includes checking the validity of the USB storage device according to the registered information therein, generating a new identification file according to a new times of using value that is incremented each time the validity checks are passed, and a unique ID number of the USB device, and writing the new identification file into the USB storage device to replace the old identification file.

### CROSS REFERENCE TO RELATED APPLICATIONS

This application claims the benefit of Chinese Patent Application No. 200710300496.4 filed Dec. 28, 2007, which is hereby incorporated by reference in its entirety.

### BACKGROUND OF THE INVENTION

The subject matter disclosed herein relates to a technique of protecting data information and, in particular, to protection of patients' information in medical system.

It is a universal requirement all over the world that the patients' information should be kept confidential and secure so as to prevent from being used inappropriately. But on the other hand, the USB (Universal Serial Bus) technique is widely used in the medical system, such as in the key board, the mouse and the USB storage disc. Although the external USB interface provided by the medical system provides a convenient way for external USB device to copy data from the medical system, meanwhile, it also brings hidden trouble to the protection of confidentiality and security of the patients' information.

### BRIEF DESCRIPTION OF THE INVENTION

The embodiments described herein provide a method for effectively protecting the patients' information from being inappropriately used or acquired when using a USB storage device for data transmission with a medical device.

A method for registering the USB storage device information to the medical system includes entering a user name that is allowed to use a USB storage device, and the medical system recording the user name, recording the port information of the USB storage device, wherein the port is the one that allows the medical system to transmit patients' information to the USB storage device. The method also includes confirming that the USB storage device is readable and writable, recording the basic information of the USB storage device by the medical system, assigning a unique ID number of USB device to the USB storage device, and recording the unique ID number of USB device. The method also includes setting the times of using of the USB storage device, encoding the unique ID number and the times of using of the USB device to generate an identification file, and storing the identification file to the USB storage device

In the method for registering the USB storage device information to the medical system according to the present invention, recording the basic information of the USB storage device includes inserting the USB storage device into the USB port of the medical system and making the medical system to read the basic information of the USB storage device.

In the method for registering the USB storage device information to the medical system according to the present invention, the basic information includes the class of the USB storage device, the sub-class of the USB storage device, manufacturer ID, product ID and product serial number.

In the method for registering the USB storage device information to the medical system according to the present invention, the initial setting of the times of using is zero.

The method for registering the USB storage device information to the medical system according to the present invention also includes setting the password for using the USB storage device and the medical system recording the password, and generating a log record for the use of the USB storage device.

The present invention further provides a medical system that includes a main control unit, a patient information storage unit, a USB port, a data transmission unit, a user operation interface, a registration information storage unit, an identification information generating unit, and a unit for check the validity of the USB device. The main control unit controls the operation state of the whole medical system. The patient information storage unit is connected to the main control unit and stores the patient's information. The USB port establishes a connection to external USB storage device and transmits data. The data transmission unit is connected between the main control unit and the USB port and is also connected to the patient information storage unit. The data transmission unit transmits data to the USB port or receives data transmitted from the USB port under the control of the main control unit. The user operation interface is connected to the main control unit for the user to operate to enter the corresponding instruction or information. The registration information storage unit is connected to the main control unit and stores the registration information registered to the medical system by the external USB storage device. The identification information generating unit is connected to the main control unit and generates the identification information that can identify the USB storage device connected to the medical system according to the registered information in the registration information storage unit. The unit for checking the validity of the USB device is connected to the main control unit and, under the control of the main control unit, compares the information obtained by the medical system about the USB storage device connected thereto and the information entered by the user through the user operation interface with the information stored in the registration information storage unit and the identification information generated by the identification information generating unit so as to determine whether they match or not, and transmits the result of determination to the main control unit; wherein, the main control unit gives the instruction of cutting off or establishing the connection to the external USB storage device based on the received result of determination sent from the USB storage device

In the medical system of the present invention, the registration information includes the user name indicating that the USB storage device can be used, wherein the user name information is entered through the user operation interface. The registration information also includes USB port information, the port being the one that allows the medical system to transmit the patient's information to the USB storage device. The registration information also includes basic information of the USB device, which includes Device class, Device sub-class, manufacturer ID, product ID and product serial number. The basic information is obtained through directly reading the USB storage device by the medical system via the USB port. The registration information also includes identification information, which includes the unique ID number and the times of using of the USB device

In the medical system of the present invention, the identification information generating unit generates the unique ID number of the USB device, and comprises a counter and an identification file generating unit. The counter sets the times of using to be zero when registering the information of the USB storage device under the control of the main control unit. When the medical system transmits the patient's data to the USB storage device, the counter adds one to the times of using for each transmission, and feeds back the result after adding one to the registration information storage unit to be stored so as to replace the original times of using. The identification file generating unit, under the control of the main control unit, obtains and encodes the unique ID number and times of using of the USB device of the registration information storage unit to generate the identification file, and transmits the newly generated identification file to the external USB storage device through the data transmission unit and the USB port to be stored under the control of the main control unit. The main control unit transmits to the external USB storage device the instruction of replacing the original identification file with the newly generated identification file.

The medical system of the present invention further comprises a using log generating unit, which, under the control of the main control unit, records the information about the state of using of the external USB storage device that obtains the patient's information in the medical system.

In the medical system of the present invention, the registration information further includes the user's password which can be entered through the user operation interface.

The present invention also provides a method for a medical system to transmit the patient's information to an external USB storage device. Registration information corresponding to each other is pre-registered in said medical system, which includes user name information, USB port information, basic information of USB device, and identification information that comprises the unique ID number and times of using of the USB device. The method includes the following steps. A connection is established between the external USB storage device and the medical system, wherein the medical system obtains the port information of the USB storage device and determines whether the existing port information matches the registered USB port information. If they do not match, the USB storage device is not usable. If they match, it is determined whether the USB storage device is readable and writable. If it is not, the USB storage device is not usable. If it is, the basic information of the USB storage device is read by the medical system, and it is determined whether the read basic information matches the basic information therein. If they do not match, the USB storage device is not usable. If they match, the medical system generates an identification file according to the identification information and determines whether the newly generated identification file matches the identification file stored within the USB storage device. If the USB storage device does not contain a identification file or the identification file therein does not match the newly generated identification file, the USB storage device is not usable. If they match, it is determined whether the entered user name matches the user name registered in the medical system to determine whether the current user has the right of user. If the user does not have enough right, the USB storage device is not usable. Otherwise, the needed patient's information is written to the USB storage device, one is added to the times of using value to obtain a new times of using value, a new identification file is generated based on the new times of using value and the unique ID number of the USB device, and the new identification file is written to the USB storage device to replace the old identification file.

In the method for a medical system to transmit the patient's information to an external USB storage device according to the present invention, the registration information also includes the user's password, and after it is determined whether the entered user name matches the user name registered in the medical system, it is determined whether the password entered by the user matches the user's password in the registration information in the medical system. If they match, the patient's information is written to the USB storage device. If they do not match, said USB storage device is not usable.

In the method for a medical system to transmit the patient's information to an external USB storage device according to the present invention, adding one to the times of using value includes generating a using log record to record the current state of using of the USB storage device.

In the method for a medical system to transmit the patient's information to an external USB storage device according to the present invention, writing the new identification file to the USB storage device includes generating a using log record to record the current state of using of the USB storage device.

In the method for a medical system to transmit the patient's information to an external USB storage device according to the present invention, the basic information of the USB device includes Device class, Device sub-class, manufacturer ID, product ID and product serial number, and the unique ID number of the USB device in the identification information is assigned by the medical system.

In the method for a medical system to transmit the patient's information to an external USB storage device according to the present invention, the identification file is obtained by encoding the unique ID number and times of using of the USB device.

The present invention pre-registers the registration information of a USB storage device to a medical system. When any USB storage device wants to obtain patient's information from the medical system, the medical system first checks the validity of the USB storage device, and the medical system transmits the patient's information to the USB storage device only when all the checks are passed, thus effectively preventing the patient's information from being obtained by irrelevant person and ensuring the security and confidentiality of the patient's information. Meanwhile, the present invention enhances the effectiveness of the method and apparatus of the invention by generating and confirming a unique, confidential and timely updated identification file. In addition, when a USB storage device obtains the information in the medical system, the present invention produces a using log to record the use of the USB storage device, so as to make it convenient for the user to check the state of using of said USB storage device and to ensure that the USB storage device to securely use and obtain the patient's information in the medical system. In summary, the invention determines and confirms the validity of the USB storage device by means of the pre-registered information and the continuously updated identification file, thereby enhancing the right for obtaining the patient's information and ensuring the security and confidentiality of the patient's information.

### BRIEF DESCRIPTION OF THE DRAWINGS

FIG. 1 shows an embodiment of using the medical system to realize protection of patient's information according to the present invention;

FIG. 2 is a flow chart of the process for the USB device to register information to the medical system according to the present invention;

FIG. 3 is a flow chart of the process for the medical system checking the validity of the USB storage device according to the present invention;

FIG. 4 is a flow chart of the process for the medical system transmitting data to the USB storage device according to the present invention;

FIG. 5 is a flow chart of updating the identification file in the invention.

### DETAILED DESCRIPTION OF THE INVENTION

The embodiments of the invention are described with reference to the drawings, but the invention is not limited to these embodiments.

The present invention registers a USB storage device in the medical system before the data transmission between the USB storage device and the medical system, so that the medical system can check the validity of the USB storage device each time it transmits the patients' information to the USB storage device, thereby preventing the patients' information from being obtained by irrelevant person and ensuring the security and confidentiality of the patients' information.

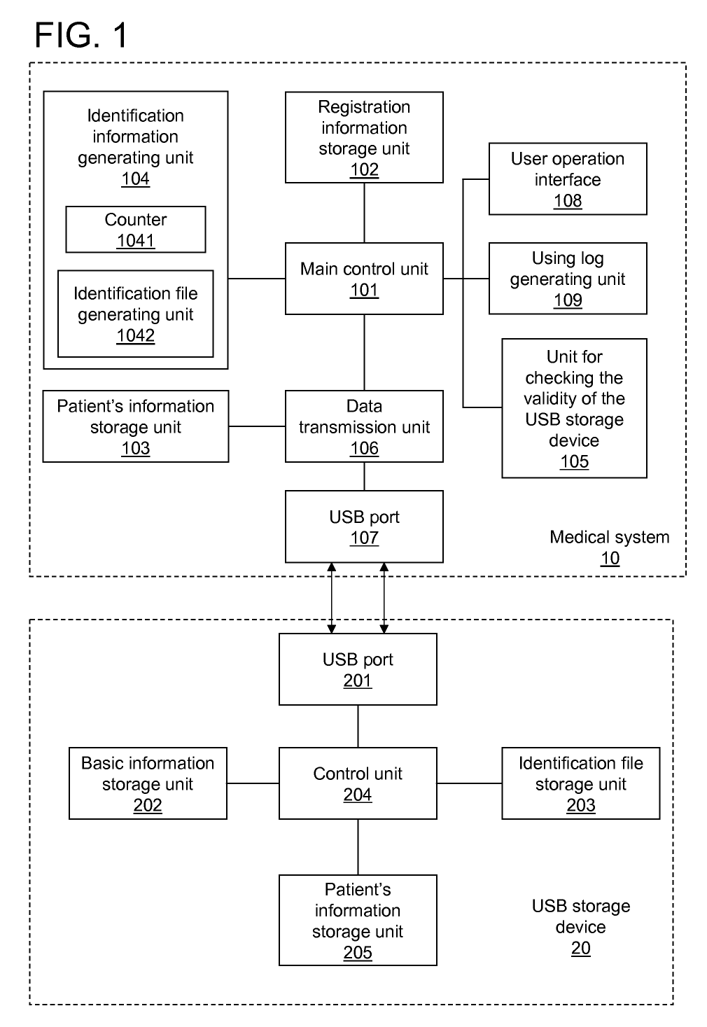

FIG. 1 shows an embodiment of using the medical system 10 to realize protection of patient's information. Data and electrical connections are established between the medical system 10 and the USB storage device 20 via a USB port. The medical system 10 comprises a main control unit 101 which controls the operation state of the whole medical system 10; a registration information storage unit 102 which is connected to the main control unit 101 to store information registered thereinto by the USB storage device; a patient's information storage unit 103 which is connected to the main control unit 101 for storing the patient's information; an identification information generating unit 104 which is connected to the main control unit 101 for generating a unique ID number and an identification file for identifying the USB storage device based on the registration information, the identification information generating unit 104 comprising a counter 1041 and an identification file generating unit 1042, the identification file generating unit 1042 generating said identification file, wherein the generated identification file is stored in the USB storage device; a user operation interface 108 connected to the main control unit, through which the user can enter information and instruction to operate the medical system 10; a unit 105 for checking the validity of the USB storage device, which is connected to the main control unit 101 for checking the validity of the USB storage device according to the registration information in the medical system and the identification file generated by the identification file generating unit 1042, thereby to determine whether the USB storage device has the right to obtain the patient's information from the medical device; a data transmission unit 106 and a USB port 107, wherein the data transmission unit 106 is connected between the main control unit 101 and the USB port 107 and is connected to the patient's information storage unit 103, and wherein the medical system 10 transmits/receipts data to/from the USB storage device 20 via the data transmission unit 106 and the USB port 107; a using log generating unit 109 which is connected to the main control unit 101 for recording the information about the transmission of data from the medical system 10 to the USB storage device and the state of using of the USB storage device, including the date, the name of the transmitted file, the time at which the using log is generated, etc. When the USB storage device 20 wants to obtain the patient's information from the medical system 10, it has to register itself to the medical system first, and after the registration is completed, the medical system 10 will check the validity of the USB storage device 20. If the check is passed, the USB storage device 20 can access the medical system 10 to obtain the patient's information therefrom.

In this embodiment, the registration information storage unit 102 includes information registered by the USB storage device 20 to the medical device 10. The information includes the user name, which indicates that the user can use the USB storage device 20. The user may set the user name by entering it through the user operation interface 108. The information also includes the USB port information, wherein the USB port is used for transmitting information to the USB storage device 20. The medical system 10 may have a plurality of USB ports, but according to the principle of minimum necessity, one USB port is usually enough. The information may also include the device basic information. According to the specification of the USB, each USB device has only one device descriptor which describes the basic information of the USB device. The basic information includes but not limited to Device class, Device sub-class, manufacturer ID, product ID and product serial number. If the specification of the USB device is well complied with, each USB storage device can be uniquely determined through the device basic information thereof. The information may also include identification information which includes the unique ID number and the times of using of the USB storage device. The unique ID number of the USB storage device can be randomly generated by the identification information generating unit 104 or be generated according to the basic information of the USB storage device. The times of using is initially set to be zero when registering, and after registration, each time there is record of transmission of a patient's information to the USB storage device, the main control unit 101 controls the counter 1041 in the identification information generating unit 104 to add one to the times of using. The identification file generating unit 1042 encodes the unique ID number and the times of using of the USB storage device by the encoding method such as MD5 to generate an identification file which comprises the unique ID number and the times of using of the USB storage device and is stored in the USB storage device. The information may also include the user's password. The user can set the password through the user operation interface 108 to enhance the security, but it should be understood by one of ordinary skill in the art that the user's password is optional.

The USB storage device 20 comprises a USB port 201 which cooperates with the USB port 107 in the medical system 10; a basic information storage unit 202 which stores the basic information of the USB storage device 20, including Device class, Device sub-class, manufacturer ID, product ID and product serial number, etc.; an identification file storage unit 203 which stores the identification file generated by the identification file generating unit 1042 in the medical system 10; a control unit 204 which controls the operation state of the whole USB storage device 20; a patient's information storage unit 205 which stores the patient's information obtained from the medical system 10 by the USB storage device 20.

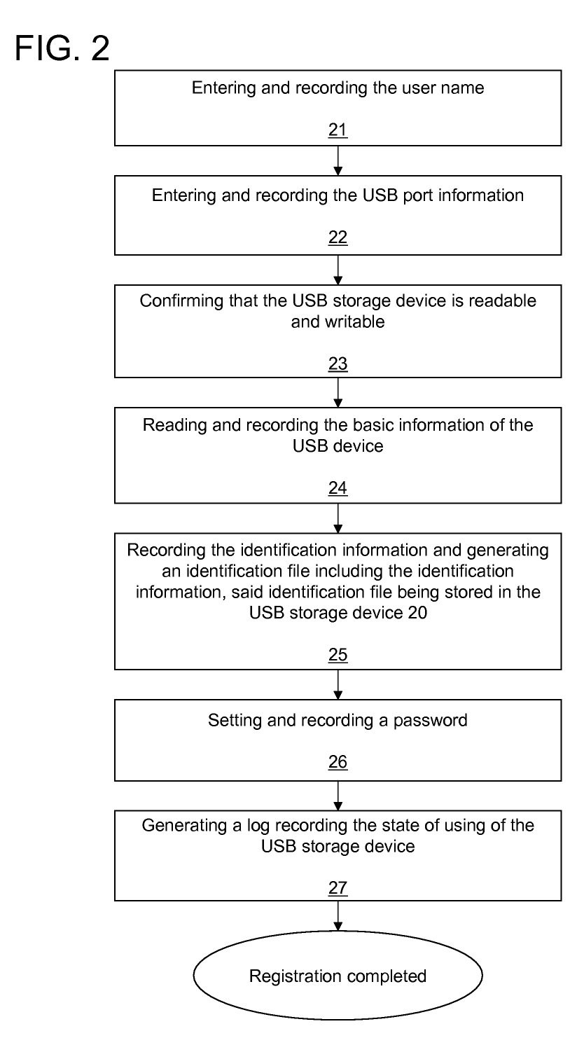

As shown in FIG. 2, the process of registration includes the following steps. At step 21, the user name is entered that is allowed to use the USB storage device, and the medical system 10 records the user name and stores it in the registration information storage unit 102. At step 22, the port information of the USB storage device is recorded, wherein port is the one that allows the medical system 10 to transmit the patient's information to the USB storage device 20. The medical system records the USB port information and stores it in the registration information storage unit 102. At step 23, it is confirmed that the USB storage device is readable and writable. At step 24, the medical system 10 records the basic information of the USB storage device. The basic information of the USB storage device can be entered into the medical system 10, in the present embodiment, by inserting the USB storage device 20 into the USB port 107 of the medical system 10 so that the medical system 10 reads the basic information of the USB storage device 20. At step 25, the identification information is recorded and an identification file is generated including the identification information. The identification file is stored in the USB storage device 20.

Recording the identification information and generating an identification file includes the following steps. A unique ID number is assigned to the USB storage device, and the times of using value is set to zero. An identification file is generated through an encoding method, wherein the identification file includes the unique ID number and the times of using value of the USB storage device. The identification file is stored into the USB storage device. Generation of the identification file and the unique ID number of the USB storage device 20 in this step are executed by the identification file generating unit 1042 and the counter 1041 in the medical system 10. At step 26, the user may set a password through the user operation interface 108 to enhance the security. Some embodiments do not require the user to set a password. At step 27, a using log record is generated for the state of using of the USB storage device. The using log record is used for the purposes of security check and failure recovery. Said step is executed by the using log generating unit 1011.

After the completion of the above seven steps, the registration information described above is recorded in the medical system 10. The identification file is stored in the USB storage device, and thus the step of registering the USB storage device 20 to the medical system 10 is completed.

For the sake of security as mentioned in the invention, the registration information preferably uses only the ways of entering, accessing and changing with authority.

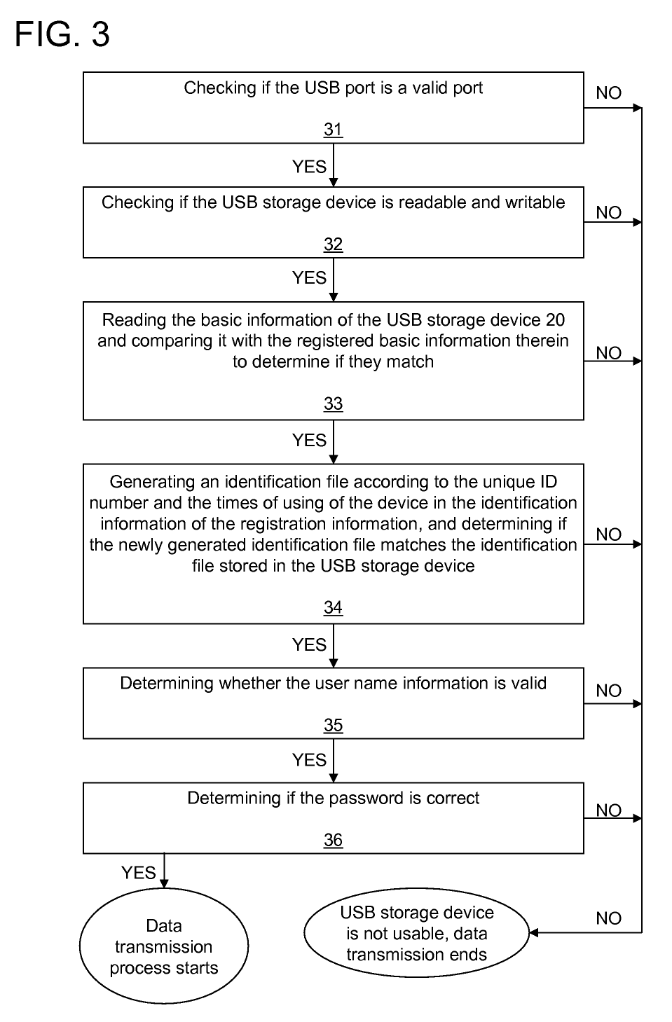

When the medical system 10 transmits the patient's information to the USB storage device 20, the unit 105 for checking the validity of the USB storage device in the medical system 10 will first check the validity of the USB storage device 20, and it compares the information of the USB storage device obtained by the medical system 10 to the information stored in the registration information storage unit 102 and the identification file generated by the identification file generating unit to determine the validity of the USB storage device. Reference should also be made to FIG. 3 which shows the flow chart of checking the validity of the USB storage device 20. At step 31, it is determined whether the USB port is a valid port by comparing the present USB port information with the USB port information in the registration information storage unit 102 of the medical system 10. If they do not match, the USB storage device is not usable. If they do match, at step 32, it is determined whether the USB storage device is readable and writable. If it is not, the USB storage device 20 is not usable. If it is, at step 33, the medical system 10 reads the basic information in the basic information storage unit 202 of the USB storage device 20 and compares it with the registered basic information stored therein. If they do not match, the USB storage device is not usable. If they match, at step 34 the medical system generates an identification file according to the identification information of the registration information therein. The identification file includes identification information, i.e. including the unique ID number and times of using of the USB storage device. The medical system 10 then compares the generated identification file with the identification file stored in the USB storage device. If the USB storage device 20 does not include the identification file or if they do not match, the USB storage device 20 is not usable. If the USB storage device 20 includes the identification file and the identification file matches the identification file generated by the medical system 10, at step 35 it is determined whether the present user has the right to transfer the patient's information. The transfer right being is by the user name, i.e. the information of type 1 in the registration information. If the user does not have the right, the USB storage device is not usable. Otherwise, the USB storage device 20 is usable

If the user optionally adds a password when registering information, the user has to enter the password after passing the right confirmation, if the entered password matches the password in the registration information stored in the medical system 10, the USB storage device is usable; otherwise, it is not usable.

The unit 105 for checking the validity of the USB device feeds back the result of checking to the main control unit 101, and the main control unit makes the decision of proceeding to the subsequent step or stopping information transmission to the USB storage device 20 according to the received feedback. If all the above steps of checking are passed, then said USB storage device 20 is valid and has access to the medical system 10, so data transmission is enabled between the medical system 10 and the USB storage device 20 and the patient's information is transmitted to the USB storage device 20. In the present embodiment, the main control unit 101 controls the data transmission unit 106 to obtain the patient's information needed by the USB storage unit 20 from the patients' information storage unit 103 and transmits it to the USB storage device 20 through the USB port 107. Meanwhile, the main control unit 101 also controls the counter 1041 in the identification information generating unit 104 to add one to the original times of using, and feeds back the result after adding one to the registration information storage unit 102 to be stored so as to replace the original times of using. The identification file generating unit 1042 in the identification information generating unit 104 obtains the unique ID number of the USB storage device 20 in the registration information storage unit 102 and the times of using newly updated by the counter 1041 and encodes them to generate a new identification file, then said new identification file is stored in the identification file storage unit 203 of the USB storage device 20 to replace the old identification file. At the same time, the main control unit 101 controls the using log generating unit 109 to generate a using log record in the using log file generating unit so as to record the state of using of the USB storage device 20 that obtains the patient's data from the medical system 10, to record the update of the identification file of the USB storage device 20 and so on.

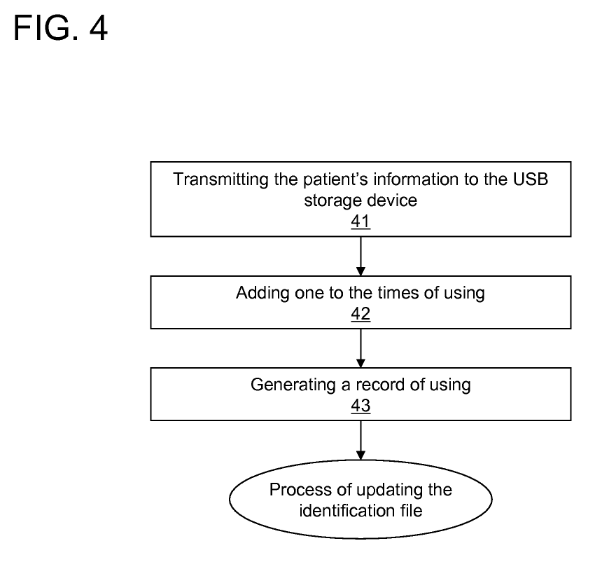

With reference to FIG. 4, the process of data transmission includes, at step 41, transmitting the patient's information to the USB storage device 20. At step 42, one is added to the times of using value in the registration information and the information of times of using in the identification information is updated. At step 43, a using log record is generated in the using log file

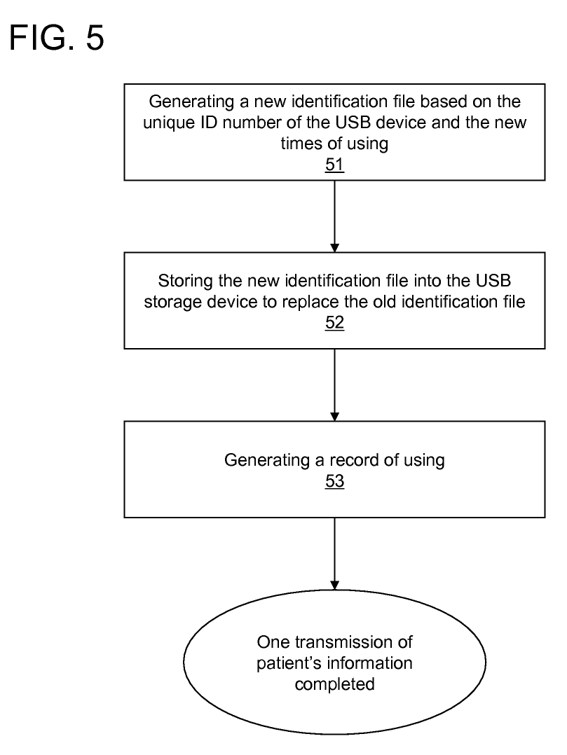

After completion of the data transmission process, the identification file is updated. FIG. 5 shows the flow chart of updating the identification file:

step 51: encoding the unique ID number and the updated times of using of the USB storage device 20 to generate a new identification file;

step 52: writing the generated new identification file into the USB storage device 20 to replace the old identification file;

step 53: generating a log record in the using log file to record the present state of using of the USB storage device.

1. A method for registering the information of a USB storage device to a medical system, said method comprising:
entering a user name that is allowed to use the USB storage device;
recording the user name in the medical system;
recording port information of the USB storage device, the port being one that enables the medical system to transmit patient information to the USB storage device;
determining whether the USB storage device is readable and writable;
recording basic information related to the USB storage device in the medical system;
assigning a unique ID number to the USB storage device, and recording the unique ID number;
setting a times of using value for the USB storage device;
encoding the unique ID number and the times of using value of the USB device to generate an identification file; and
storing the identification file in the USB storage device.

2. The method according to claim 1, wherein recording basic information related to the USB storage device comprises inserting the USB storage device into a USB port of the medical system and reading, by the medical system, the basic information of the USB storage device.

3. The method according to claim 1, wherein the basic information includes the class of the USB storage device, the sub-class of the USB storage device, manufacturer ID, product ID and product serial number.

4. The method according to claim 1, further comprising setting the times of using value to zero initially.

5. The method according to claim 1, further comprising:
setting a password for using the USB storage device;
recording the password in the medical system; and
generating a log record of using of the USB storage device.

6. A medical system, comprising:
a main control unit configured to control an operation state of said medical system;
a patient information storage unit coupled to said main control unit, said patient information storage unit configured to store patient information;
a USB port configured to establish a connection to an external USB storage device and to transmit data;
a data transmission unit coupled to said main control unit, said USB port, and said patient information storage unit, said data transmission unit configured to transmit at least one of data to said USB port and receive data transmitted from said USB port under the control of said main control unit;
a user operation interface coupled to said main control unit to enable a user to enter at least one of the corresponding instruction and information;
a registration information storage unit coupled to said main control unit, said registration information storage unit configured to store the registration information registered to said medical system by the USB storage device;
an identification information generating unit coupled to said main control unit, said identification information generating unit configured to generate identification information that identifiers the USB storage device connected to said medical system according to the registered information in said registration information storage unit;
a validity checking unit coupled to said main control unit, said validity checking unit configured to compare the information obtained by said medical system about the USB storage device connected thereto and the information entered by the user through said user operation interface with the information stored in said registration information storage unit and said identification information generated by said identification information generating unit in order to determine the validity of the USB storage device and to transmit the result of comparison to said main control unit, wherein said main control unit is configured to one of grant and deny the connection to the USB storage device based on the result of the comparison.

7. The medical system of claim 6, wherein the registration information includes at least one of:
a user name indicating that the USB storage device can be used, the user name being entered through said user operation interface;
USB port information, wherein said USB port enables said medical system to transmit patient information to the USB storage device;
basic information of the USB storage device including at least one of a Device class, a Device sub-class, a manufacturer ID, a product ID, and a product serial number, wherein the basic information is obtained through directly reading the USB storage device by said medical system via the said USB port; and
identification information including at least one of a unique ID number and a times of using value associated with the USB storage device.

8. The medical system of claim 7, wherein:
said identification information generating unit is configured to generate the unique ID number of the USB storage device, said identification information generating unit comprises a counter and an identification file generating unit, said counter is configured to set the times of using value to zero when registering the information of the USB storage device under the control of said main control unit, and when said medical system transmits the patient data to the USB storage device, said counter is configured to add one to the times of using value for each transmission, and to transmit the incremented times of using value to said registration information storage unit to be stored in order to replace the original times of using value; and
said identification file generating unit, under the control of said main control unit, is configured to obtain and encode the unique ID number and times of using value associated with the USB storage device for said registration information storage unit in order to generate the identification file, and said identification file generating unit further configured to transmit the newly generated identification file to the USB storage device via said data transmission unit and said USB port to be stored under the control of said main control unit, said main control unit is further configured to transmit instructions to the USB storage device to replace an original identification file with the newly generated identification file.

9. The medical system of claim 8, further comprising a using log generating unit configured to record the information about a state of using of the USB storage device.

10. The medical system of claim 9, wherein the registration information further includes the user's password which can be entered through said user operation interface.

11. A method for a medical system to transmit patient information to an external USB storage device, said method comprising:
pre-registering registration information and identification information in the medical system, the registration information including user name information, USB port information, basic information of the USB storage device, and the identification information including a unique ID number and a times of using, value associated with the USB storage device;
establishing a connection between the USB storage device and the medical system;
obtaining USB port information of the USB storage device;
determining whether the obtained USB port information matches the pre-registered USB port information wherein the USB storage device is designated as not usable if the obtained USB port information does not match the pre-registered USB port information;
determining whether the USB storage device is readable and writable, wherein if the USB storage device is not readable and writable, said USB storage device is designated as not usable;
reading basic information of the USB storage device by the medical system;
determining whether the read basic information matches the pre-registered basic information, wherein if the read basic information does not match the pre-registered basic information, the USB storage device is designated as not usable;
generating by the medical system an identification file according to the identification and information;
determining whether the newly generated identification file matches the identification file stored within the USB storage device, wherein if the USB storage device does not contain an identification file or the identification file therein does not match the newly generated identification file, the USB storage device is designated as not usable;
determining whether an entered user name matches a user name registered in the medical system to determine whether the current user has the right of use, wherein if the user does not have enough right, the USB storage device is designated as not usable;
writing patient information to the USB storage device;
incrementing the times of using value;
generating a new identification file based on the incremented times of using value and the unique ID number of the USB storage device;
writing the new identification file to the USB storage device to replace the old identification file.

12. The method according to claim 11, wherein the registration information also includes a user password, and wherein determining whether an entered user name matches an existing user name comprises determining whether a password entered by the user matches the user password in the registration information in the medical system, such that if they do not match, the USB storage device is designated as not usable.

13. The method according to claim 11, wherein incrementing the times of using value comprises generating a using log record to record a current state of using of the USB storage device.

14. The method according to claim 11, wherein writing the new identification file to the USB storage device comprises generating a using log record to record the current state of using of the USB storage device.

15. The method according to claim 11, wherein the basic information of the USB storage device includes Device class, Device sub-class, manufacturer ID, product ID and product serial number, and the unique ID number of the USB storage device in the identification information is assigned by the medical system.

16. The method according to claim 11, further comprising generating the identification file by encoding the unique ID number and times of using value associated with the USB storage device.
